(19) United States
(12) Patent Application Publication
(10) Pub. No.: US 2018/0038694 A1
(43) Pub. Date: Feb. 8, 2018

(54) ULTRA WIDE BAND RADAR LOCALIZATION

(71) Applicant: 5D Robotics, Inc., Carlsbad, CA (US)

(72) Inventors: David Bruemmer, Carlsbad, CA (US); Brandon Dewberry, Carlsbad, CA (US)

(73) Assignee: 5D Robotics, Inc., Carlsbad, CA (US)

(21) Appl. No.: 15/427,773

(22) Filed: Feb. 8, 2017

Related U.S. Application Data
(60) Provisional application No. 62/293,079, filed on Feb. 9, 2016.
(60) Provisional application No. 62/364,004, filed on Jul. 19, 2016.

(51) Int. Cl. G01C 21/00; G01S 13/86; G01S 13/02

(52) U.S. Cl. CPC G01C 21/005; G01S 13/0209; G01S 13/865; G01S 13/931

(57) ABSTRACT

Coherent radar returns gained from Ultra-Wideband Radars are correlated with features extracted from a georeferenced map to refine positional information and pose of an object. Data collected from one or more UWB Radars and other real time sensors affixed on an object can be processed to identify discrete edges or characteristic returns such as a pole, building or the like. These coherent returns can be correlated with features extracted from a georeferenced map. As the UWB Radar(s) location and orientation with respect to the object is (are) known the precise location and pose of the object on the georeferenced map can be determined by matching features found in the map or imagery with those of the coherent return. Moreover the configuration of the UWB Radars can be modified based on a perception of the local environment.

### RELATED APPLICATION

The present application relates to and claims the benefit of priority to U.S. Provisional Patent Application No. 62/293079 filed Feb. 9, 2016 and U.S. Provisional Patent Application No. 62/364004 filed Jul. 19, 2016, both of which are hereby incorporated by reference in their entirety for all purposes as if fully set forth herein.

### BACKGROUND OF THE INVENTION

Field of the Invention

Embodiments of the present invention relate, in general, to localization and more particularly to spatial localization (or positioning) of objects using Ultra-Wide Band (“UWB”) RADAR.

Relevant Background

Radar is used in many applications to detect target objects such as airplanes, military targets, and vehicles. A radar system may detect the range (i.e., distance) to a target object by determining the roundtrip delay period between the transmission of a radar signal and the receipt of the signal returning to the radar after it bounces off the target object. This round-trip delay, divided in half and then multiplied by the speed of the radiation, c (the speed of light), gives the distance between the radar system and the target object (assuming the transmitting antenna and the receiving antenna are the same antenna or very close to each other). More recently, radar systems have been implemented in automobiles. Automotive radar systems are known for use in helping drivers to park their cars, to follow traffic at a safe distance, and to detect driving obstacles. In such applications, when the radar system detects an obstacle or the slowing down of traffic in front of the vehicle, it may issue a warning to the driver such as a beep or warning light on the dashboard, and/or control the vehicle in some way such as by applying the brakes, in order to avoid an accident. Such automotive radar systems include UWB technology.

Ultra-Wide Band (“UWB”) is a radio frequency (RF) technology using extremely short-duration pulses of RF energy. The extremely short-duration pulses in the time domain translate into a very wide frequency spectrum (typically more than 1 GHz wide) in the frequency domain. The technology can be used for communications, radar, and ranging/location applications. Ultra-Wide Band Radar systems transmit signals across a much wider frequency than conventional radar systems and are well suited to use in environments such as automobiles, because of their very compact size, fine spatial resolution, extraction of target feature characteristics, low probability of interception and non-interfering signal waveform—all of which make UWB Radar appealing to such applications. The large signal bandwidth and information carried by the UWB Radar return signal provides an expanded sensing and communications capability, as well. The waveform content of reflected UWB impulse signals change depending on the target's shape, orientation and material. In addition, the UWB Radar's fine spatial resolution provides for fine target imaging and discrimination of the targets from background clutter.

Automotive radar technology can assist in ascertaining information with respect to the immediate surroundings. However automotive radar technology, including UWB Radar technology, is insufficient by itself to provide adequate geospatial information to enable autonomous operations. Similarly, passive positional technology fails to deliver adequate accuracy with respect to an object's position and pose in its environment to enable autonomous operations. What is needed is the ability to capture fine details with respect to an object's surrounding environment through the use of radar technology such as UWB Radar and correlate that information with an object's georeferenced position on a map. Moreover, a need exists to dynamically modify radar configurations based on the environment to optimally capture data surrounding an object. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Coherent returns from a UWB Radar are correlated with features of a georeferenced map to refine positional data of an object. One embodiment of the present invention captures coherent returns from one or more UWB Radars affixed to an object such as a vehicle. In one embodiment of the present invention, the UWB radar transmits an ultra-wideband signal at a skewed angle from the path of the object, and processes the received signal reflections from topologically-contiguous features such as curbs, railings and buildings as well as prominent topographies such as poles and other prominent features. These features clearly mark the road's edge and its surrounding environment. Moreover, the invention's unique capability to fuse these UWB returns enables it to reliably and consistently determine an object's position and pose. Unlike other technology, UWB Radar signals possess the ability to capture edge and contour features even in obscurant-dense conditions caused by dust, fog, rain, snow, sleet and other particulates. These conditions would otherwise interfere with or preclude such sensing capabilities in other non-wideband sensors such as LiDAR, cameras, single- or narrowband sensors or myriad other types of non-wideband sensors.

By correlating real-time data and extracting edges or features from the data with the features from aerial imagery it is possible to provide a position correction that can be used not only for autonomous driving, but for improving vehicle-related applications that require accurate positioning. The dual aspect of reactive contour following coupled with next-generation localization provides a highly flexible overall solution.

The present invention also allows for tremendous variation in terms of the infrastructure used to support this UWB-based system. Active UWB “beacons” as well as passive reflectors can be affixed in an infinite number of configurations within the infrastructure, enabling the UWB Radar to improve positioning and keep track of motion. Moreover, even if no UWB infrastructure is used (i.e., no active tags or reflectors are used), the system can locate organic features for localization and contour-following. Thus, the present invention can be used regardless of the level of adoption. The ubiquitous presence of features such as curbs, railings and buildings and other prominent features can be exploited easily by the UWB Radar's ability to track both large continuous surfaces as well as prominent features, and still ignore noise in the environment.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high-level block diagram of a system for UWB Radar Localization according to one embodiment of the present invention;

FIGS. 2A-2C depict a waterfall image of a single monostatic UWB Radar affixed to an object as the object travels forward according to one embodiment of the present invention;

FIG. 3 is a flowchart of a method embodiment for UWB Radar localization according to one embodiment of the present invention;

FIG. 4 is a high-level block diagram of a UWB Radar processing and perception system according to one embodiment of the present invention;

FIGS. 5A-5D is a depiction of a monostatic UWB Radar and a plot of reflectivity vs. distance as implemented according to one embodiment of the present invention;

FIG. 6 is a depiction of a sparse UWB Radar array; and

FIG. 7 is a depiction of a parallel UWB Radar array.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

UWB Radar Localization correlates coherent radar returns with features extracted from a georeferenced map to refine positional information of an object. Data collected from one or more UWB Radars along with other real-time sensors can be processed to identify discrete real-time features or characteristic returns such as a pole or building. These real-time extracted features can be correlated with features extracted from a georeferenced map to provide a position correction. As the UWB Radar(s) location and orientation with respect to the object is (are) known the precise location and pose of the object on the georeferenced map can be determined by matching features found in the map or imagery with those of the coherent return.

An object may be associated with a plurality of UWB Radars affixed at various positions and orientations. Each of the UWB Radars are, according to one embodiment of the present invention, coupled to a Radar Processor or Radar Orchestration engine that optimizes and configures each individual UWB Radar unit based on a perception of the coherent return. For example, a plurality of UWB Radars may be configured as parallel array in one instance while in another the individual UWB Radars may operate as a sparse array or as a serial array.

Embodiments of UWB Radar Localization are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

The term “GPS” refers to the U.S. Global Positioning System, but any similar localization system (e.g., Russia's “GLONASS” or Europe's “Galileo”, etc.) can be used and the use of “GPS” broadly refers to all such schemes and localization systems.

“Trilateration” is a technique that determines position based on distance information from uniquely-identifiable ranging radios. In trilateration, the position of a mobile node can be calculated using the known positions of multiple RF reference beacons (anchors) and measurements of the distances between the mobile node and the anchors. The anchor nodes can pinpoint the mobile node by geometrically forming four or more spheres surrounding the anchor nodes which intersect at a single point that is the location of the mobile node. Trilateration has strict infrastructure requirements, requiring at least three anchor nodes for a 2D position and four anchor nodes for a 3D position. The technique is further complicated by being heavily dependent on relative node geometry and suffers from accuracy errors due to RF propagation complexities including multipath errors.

“Triangulation” is a technique for establishing the distance between any two points, or the relative position of two or more points, by using such points as vertices of a triangle or series of triangles, such that each triangle has a side of known or measurable length that permits the size of the angles of the triangle and the length of its other two sides to be established by observations taken either upon or from the two ends of the base line.

Time Distance of Arrival (“TDOA”) determines an object's location by merely receiving broadcast signals. In TDOA a plurality of nodes, such as in a UWB Radio localization system, broadcast a signal at a precise time. The receiving UWB node receives two or more packets related to the same signal and notes each time of arrival. Knowing the location of the transmitting nodes and the different times that the same signal arrived at the receiving node, the receiving nodes location can be determined. When any two other nodes in the area perform a two-way ranging conversation a node can overhear both the request packet and the response packet and measures the time difference of arrival of each. This time difference along with the locations and location errors of these transmitters (which they included in their signal) is used for updating current position of the eaves dropping node.

“Two-Way Ranging” is the ability of UWB tags or radios to establish two-way ranging between objects (UWB Radio localization system). In such an instance one radio (tag) transmits a request packet to another “target” tag. The target tag acquires the message, demodulates the packet and notes its precise time of arrival. After a precise and predetermined delay, relative to the time or arrival, the target tag sends a response to the tag originating the message. The requesting tag receives the response and notes the time of arrival of the response. Knowing this is a two-way communication with a precise respondent, the receiving tag calculates the total time from when the request was originally sent to when the response was received, subtracts the known delay and multiples the result by c/2.

“LiDAR”, which stands for Light Detection and Ranging, is a sensing method that uses light in the form of a pulsed laser to measure ranges (variable distances) to an object. These light pulses—combined with other data recorded by the LiDAR system—generate precise, three-dimensional information about the shape of the object and its surface characteristics.

When a laser is pointed at a targeted area, the beam of light is reflected by the surface it encounters. A sensor records this reflected light to measure a range. When myriad laser ranges are combined with position and orientation data generated from integrated GPS and Inertial Measurement Unit systems, scan angles and calibration data, the result is a dense, detail-rich group of points called a “point cloud.”

Each point in the point cloud has spatial coordinates that correspond to a particular point on the object's surface from which a laser pulse was reflected. The point clouds are used to generate products such as digital topographic models, canopy models, building models and contour models.

In robotic mapping, Simultaneous Localization and Mapping (“SLAM”) is the computational problem of constructing or updating a map of an unknown environment while simultaneously keeping track of an objects location within it. Popular approximate solution methods include the particle filter and extended Kalman filter solutions. SLAM algorithms are tailored to the available resources, hence not aimed at perfection, but at operational compliance.

“Pose” is the combination of position and orientation of an object relative to some coordinate system, even though this concept is sometimes used only to describe the orientation.

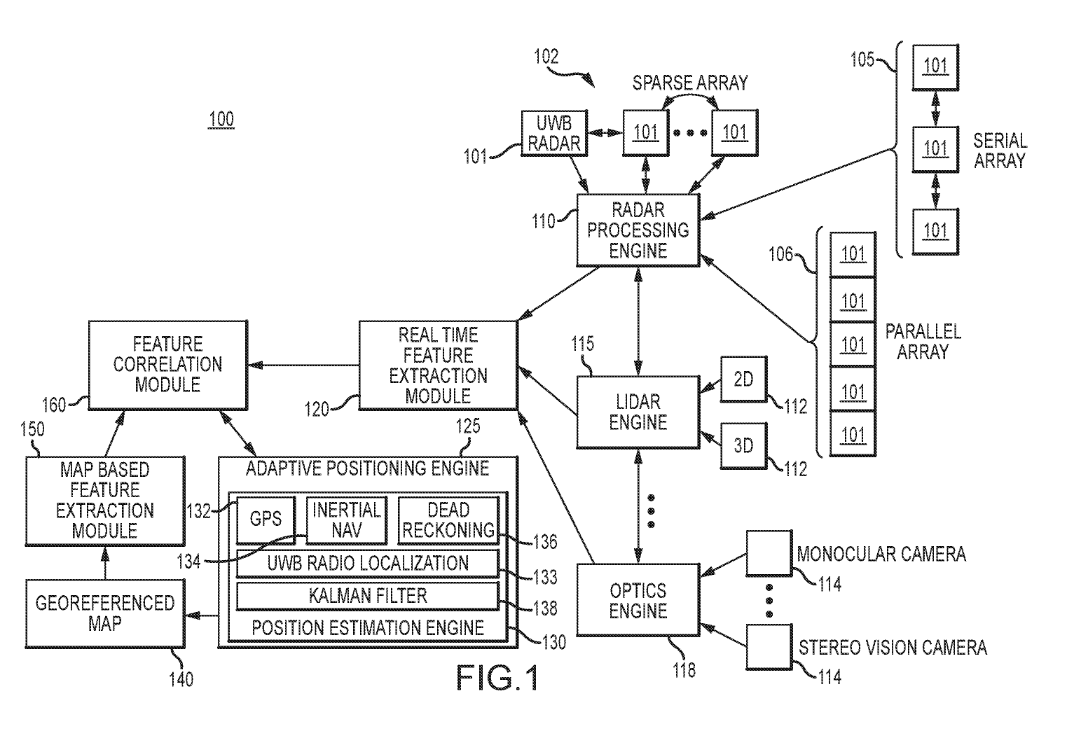

FIG. 1 is a high-level block diagram of a system for UWB Radar Localization according to one embodiment of the present invention. Autonomous operations (self-driving cars and the like) require precise positional determination. Various positional sensors such as UWB Radar, LiDAR, optics, GPS, Dead Reckoning, etc. can be combined to provide a collaborative determination of an object's exact location. This position can be correlated with a georeferenced map to enable accurate behavioral actions. For, example, it is common to program into a navigation system a location such as a residence or a place of business. But it is entirely another matter for the vehicle to determine when to turn off the road so that the wheels of the vehicle are aligned with the driveway or the park in a parking spot. The present invention correlates real time sensor data from one or more UWB Radars, LiDAR and/or optics with GPS, Initial Navigation, Dead Reckoning and other positional techniques, tied to a georeferenced map, to ascertain a precise positional determination and pose.

An object is configured with a plurality of sensors including UWB Radars 101, LiDAR 112, UWB radio localization 133, and Optic sensors 114. Data from each sensor are collected and processed and combined to identify salient features of the object's environment. In the case of the one or more UWB Radars 101, coherent returns are gathered and communicated to a Radar Processing Engine 110. Using various filtering and optimization techniques as would be known to one skilled in the art of UWB Radar technology, the returns are analyzed to identify specific real time characteristics or features. The Real Time Feature Extraction Module 120 examines each, in the case of coherent return radar data, to identify features such as the edge of pavement, a curb, a fence, a passing light pole or street signal, or a house or office building. The combination of these “edges” or “features” at a point of time presents a signature environment. And as each UWB radar 101 is affixed on the object, a precise distance and angle to the edge from the object is known.

The UWB Radar localization system 100 further includes an Adaptive Positioning Engine 125 that possesses within it a Position Estimation Module 130. The Adaptive Positioning Engine 125 is further associated with a Georeferenced Map 140 and thereafter a Map Based Feature Extraction Module 150. Beyond UWB Radars 101, LiDAR systems 112 and optical sensors 114, the object also likely includes Global Position Satellite (“GPS”) 132 capability, Inertial Navigation Systems (“INS”) 134, Dead Reckoning 136, UWB Radio localization 133 and the like. GPS, INS, Dead Reckoning and other passive positional techniques are each capable of establishing the geospatial position of an object within a certain degree of certainly as is UWB radio localization. Each possesses advantages and disadvantages. For example, GPS is prone to multipath errors in urban environments while the accuracy of Dead Reckoning and wheel encoding diminishes over time. Similarly, an INS can drift.

The Position Estimation Module 130 uses positional information from the GPS,

INS, Dead Reckoning, UWB Radios, and the like, processed through a Kalman filter 138, to provide an estimated location of the object. The estimated location can be ascertained on a georeferenced map by the Georeferenced Map Module 140. Similar maps include a ortho-rectified laser map, ortho-rectified photogrammetry map or ortho-rectified overhead imagery map from a satellite, drone or plane. Georeferencing means that the internal coordinate system of a map or aerial photo image can be related to a ground system of geographic coordinates. The relevant coordinate transforms are typically stored within the image file (GeoPDF and GeoTIFF are examples), though there are many possible mechanisms for implementing georeferencing. In other words, Georeferencing means to associate something with locations in physical space. The term is commonly used in the geographic information systems field to describe the process of associating a physical map or raster image of a map with spatial locations. For example, a map may depict a lake. A georeferenced map will associate the depicted lake with an actual image of the lake from satellite imagery.

With the object's estimated position ascertained on a georeferenced map, the Map

Based Feature Extraction Module 150 can extract features within a predetermined distance of the objects estimated location. One skilled in the relevant art will appreciate that an operable GPS, INS or UWB Radio localization system may be able to pinpoint the objects location within a few meters. However, for autonomous operations the objects location must be determined very precisely. This degree of accuracy is achieved by correlating features extracted from the georeferenced map with real time features identified through the UWB Radar, LiDAR or Optics.

A Feature Correlation Module 160 is interposed and communicatively coupled to the Map Based Feature Extraction Module 150 and the Real Time Feature Extraction Module 120. At an instance in time, the UWB Radar Processing Engine 110, the LiDAR Engine 115 and the Optics Engine 118 capture characteristic real-time features that present a fingerprint of the environment surrounding the object's location. The Feature Correlation Module 160 matches the fingerprint of real time features with map based features extracted from the Georeferenced Map 140. When the overlays match, the precise location of the object as well as its pose can be determined using a vector-matching algorithm. A vector-matching algorithm, point-cloud-library-(PCL)-matching, or other curve-matching algorithm(s) correlates the edge feature data extracted from the map image area with the edge tracking data from UWB Radar images. The results of such a vector-matching algorithm can identify any necessary orientation correction to transform the current GPS/INS-derived position (x, y, theta) to the actual relative position of the vehicle relative to the radar-detected features (i.e. the curb). Finally, the inverse of this correction transform can be used to correlate the true position of the car to its position on an ortho-rectified map or other map, using the newly-menstruated coordinates.

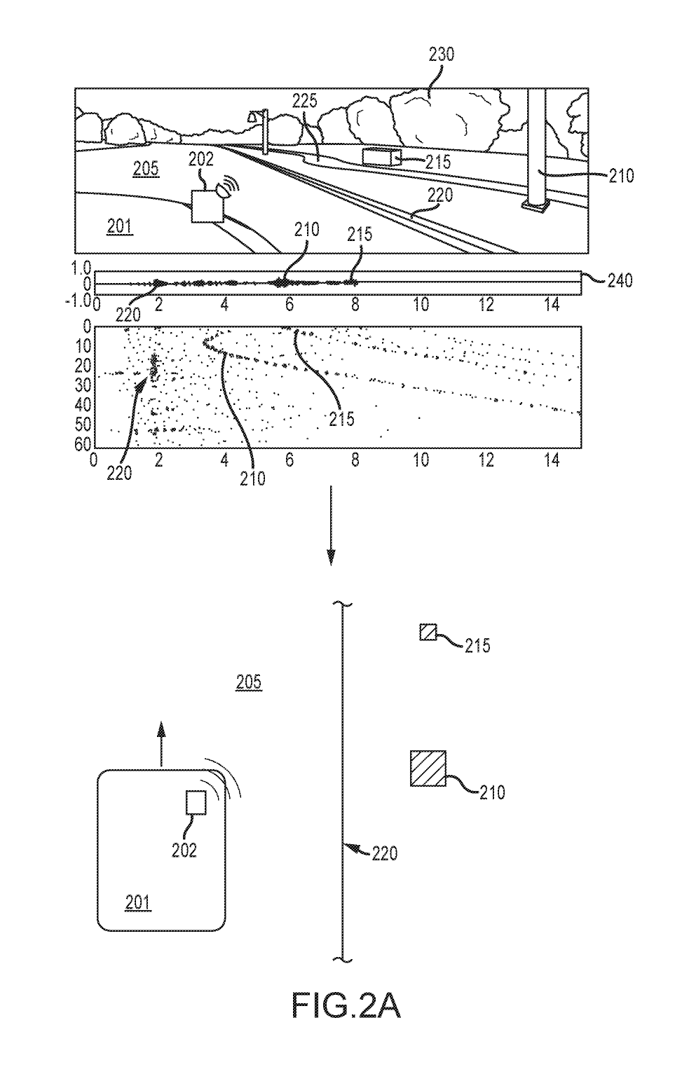

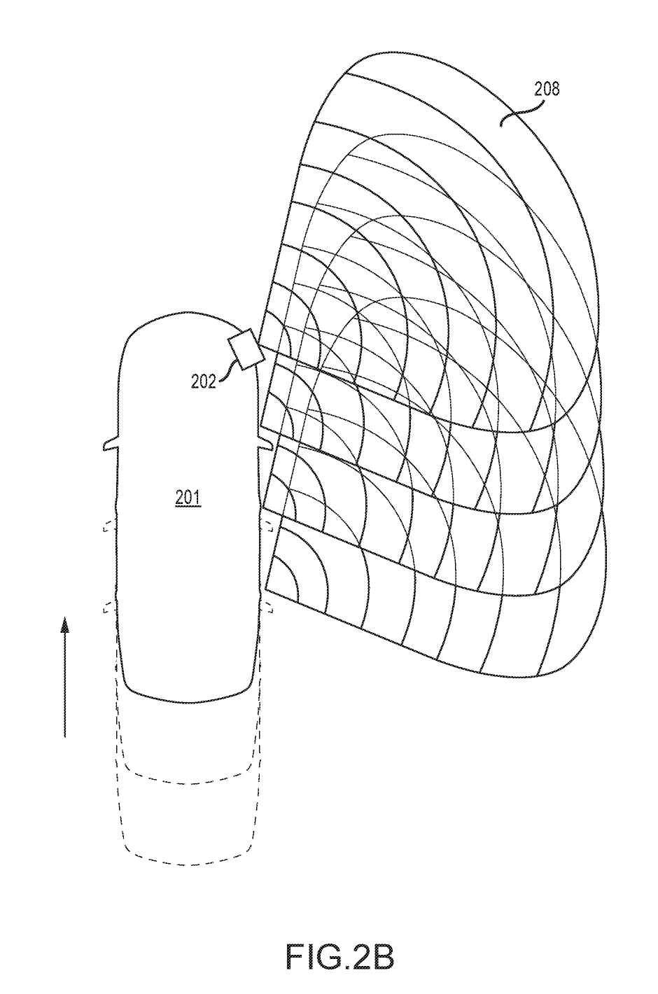

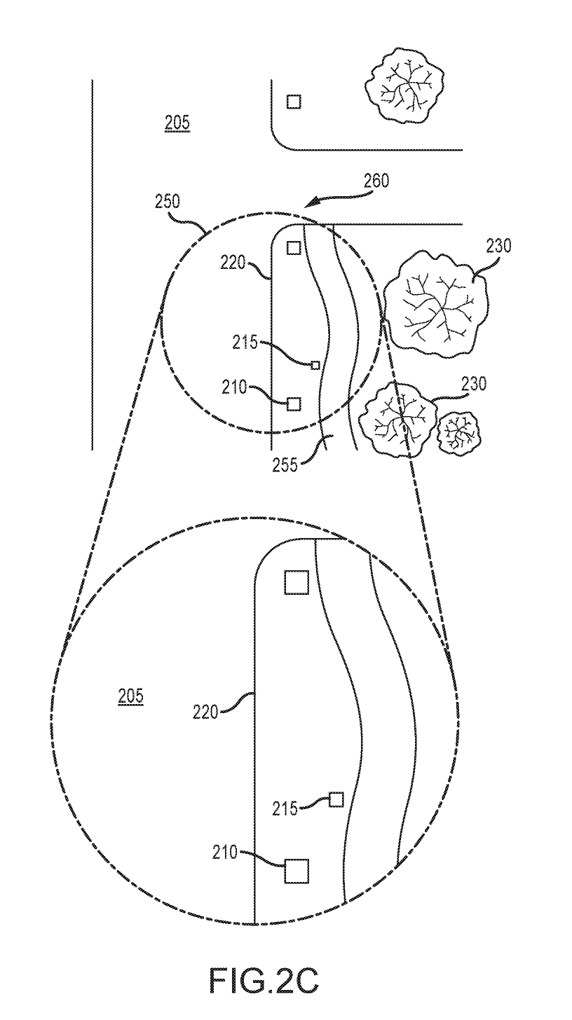

The refined location and pose of the object is passed to the Adaptive Position Engine which can thereafter use that information to affect operations and behavior of the object. To better understand the present invention, consider the following example. Assume a single UWB Radar transceiver is placed in the forward portion of an object (a vehicle), with a directional antenna canted to the side as shown in FIG. 2A. Unlike optical or other line-of-sight-based sensors, UWB Radar does not require an unimpeded line of sight to be effective. Thus, it can be obscured or hidden behind any non-metallic facade. Optimally, the UWB Radar is positioned near the forward corner of the vehicle and directed outward at an angle of 45 to 60 degrees from an axis parallel to the longitudinal axis of the vehicle (i.e., its direction of travel), depending on the field of view of the UWB Radar antenna. In other embodiments, a number of UWB radars are electronically steered using various steering schemes (phased array, serial array, passive/active electronically scanned arrays, etc.) to provide precisely set a desired field of view through dynamic beam-forming. This capability is especially useful on winding roads.

As the vehicle travels down the road 205 as shown in FIG. 2B, the UWB Radar 202 transmits and thereafter receives reflected energy from sequential radar scans. Each scan receives reflected energy, providing range and other information. Sequential scans as shown in FIG. 2B provide a presentation over time of features in the roadway environment. Radar returns reflected from prominent features also enable identification of individual objects. A pole 210 or curb 220, for example, provide characteristic returns.

FIG. 2A is a snapshot in time of a return of the UWB Radar 202 as it is about to pass a light pole 210 on the right-hand side of the object. “Noise”—defined here as anything other than the desired radar return—can be mitigated to enhance the detection of a reflected feature. By filtering data as a function of time this noise is removed, leaving only features that are solid and continuous remaining. In other embodiments, transitory objects identified by the UWB Radar—such as moving vehicles, animals and the like—can be removed from consideration or classified as a distinct category of object to be evaluated. An edge tracking algorithm identifies those reflections that have consistently remained in the same location for a predetermined period of time as “coherent features”.

In this case, the curb 220 of the road is visible as are some other utility boxes 215 ahead and to the right. A sidewalk 225 can be seen as can some trees 230. The radar return 240 at this instant of time possess characteristic edges for the curb 220, the light pole 210 and the utility boxes 215. The sidewalk 225 does not present a reflective surface and is treated as noise and the trees 230 are outside of the field of view of the radar. According to one embodiment of the present invention, the Radar Processing Engine 110 passes the data shown in FIG. 2A to the Real Time Feature Extraction Module 120. The Real Time Feature Extraction Module 120 would, as shown in FIG. 1, identify a curb 220, a pole 210 and a secondary box 215 with a certain configuration. The Real Time Feature Extraction Module 120 would also place the exact location and orientation of the vehicle with respect to the curb, pole and box.

Simultaneously, the Adaptive Position Engine ascertains from the Position Estimation Module an estimated location of the object on a Georeferenced Map as depicted in FIG. 2C. As previously discussed the Position Estimation Module 130 can determine the estimated location from systems such as GPS, INS, UWB Radios, Dead Reckoning, or the like. From a Georeferenced Map 140 the Map Based Feature Extraction Module 150 extracts one or more features, within a predetermined range 250, that would be consistent with features extracted from real time sensors. In this case assume the Position Estimation Module 130 locates the object within 30 feet of a road 205. The road 205 can be seen on the Georeferenced Map 140 to have several light poles, utility boxes, trees, curbs and an intersection. The Map Based Feature Extraction Module 150 extracts those features from the Georeferenced Map 140 that would likely be visible to a Radar 202 within a predetermined distance 250 of the estimated location. In this case the curb 220, light poles 210 and curb would be visible as would be utility boxes 215. The intersection 260 is outside the predetermined distance as is the grove of trees 230. The sidewalk 255 would not be a feature recognized by real time sensors.

The Map Based Feature Extraction Module 150 and the Real Time Feature Extraction Module 120 both present to the Feature Correlation Module 160 a template of the location of the object. The Feature Correlation Module 160 overlays the template from the Map Based Feature Extraction Module 150 with that of the Real Time Feature Extraction Module 120 until they are aligned. Once aligned the Feature Correlation Module 160 informs the Adaptive Position Engine 125 of the precise or refined location of the object on the Georeferenced Map 140.

Identifying characterized detections from various distances and angles in a multi-radar and/or synthetic aperture array greatly improves the image processing of the present invention. The radar returns of “hard” features—such as metal and other highly-radar-reflective materials—produce signature characteristics very close to those of the transmitted radar pulse. In contrast, “soft” features—such as people, vegetation, animals and the like—absorb the higher frequencies from the transmitted pulse and thus substantially change the characteristics of the reflected pulse. Building materials—such as concrete, brick, asphalt and the like—fall somewhere in between these extremes of reflected pulse types. By processing these various reflected pulse types over many scans and from many varying perspectives, a coherent processed image emerges.

Coherent processed images collected from the UWB Radar can be used by various processing algorithms to identify continuous lines and curves, such as the edges of roads or pavement, which in turn can be used to determine and track current orientation and lateral positioning of a vehicle relative to the identified curb, pavement edge, railing and the like. Historical information can even be compared to the vehicle's current track to identify erratic vehicle behavior.

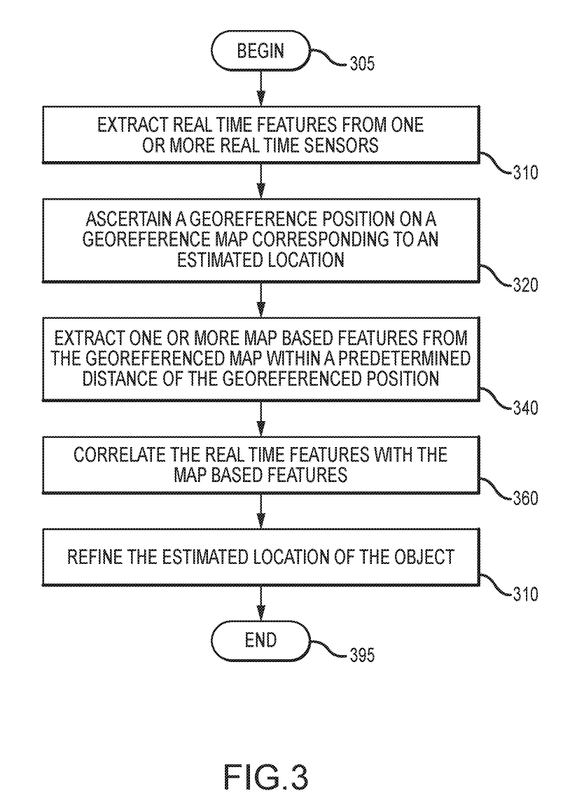

FIG. 3 is a flowchart of one method embodiment for UWB Radar Localization. In the following description, it will be understood that one or more blocks of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

One method embodiment for UWB Radar Localization, according to the present invention, begins by extracting 310 real-time features from one or more real-time sensors. As discussed hereafter, an object can be configured with a plurality of UWB Radars and each of these UWB Radars can be dynamically configured and optimized based on the environment. Configurations such as a parallel array, sparse array or serial array are contemplated by the present invention as are individually optimizing each UWB Radar based on environmental conditions. From these returns edges are identified that form a signature fingerprint of the location of the object at any instant in time.

Concurrently with the collection of coherent returns, a georeferenced position on a georeferenced map is ascertained 320 corresponding to an estimated location of the object. In practice the estimated location of the object is gained from GPS, INS or Dead Reckoning data. This information is used to gain an estimate of the object on a Georeferenced Map.

Once an estimated position on the Georeferenced Map 140 is established, the Map

Based Feature Extraction Module 150 extracts 340 one or more features from Georeferenced Map within a predetermined distance that would be recognizable by a UWB Radar or similar real time sensors. Hard features such as a curb, bridges, poles and buildings will likely produce coherent returns from the UWB Radar and are therefore extracted from the map.

The coherent returns and associated real-time features identified by the Real Time

Feature Extraction Module 120 are correlated 360 with the georeferenced position of the object on the Georeferenced Map. Features extracted by the Map Based Feature Extraction Module 150 are matched with the edges identified by the Real Time Feature Extraction Module 120. Once matched, the estimated location of the object (vehicle) is refined 380 and communicated to the Adaptive Position Engine 125.

One or reasonable skill in the relevant art will recognize that the process outlined above is dynamic and iterative. As the vehicle is in motion it will collect multiple Radar return snapshots that can be correlated with features extracted from a Georeferenced Map. The estimated position of the object, originally determined by GPS, INS or Dead Reckoning, can be refined based on prior Radar Localization making subsequent correlations and refinements more efficient.

In another embodiment of the present invention, the UWB radar can focus on a continuous feature by narrowing the range gate of the radar so that it is biased to focus on that particular feature. Increasing the pulse update rate likewise enables the UWB radar to provide a more reliable means to track continuous features such as buildings, curbs, highway railings and the like.

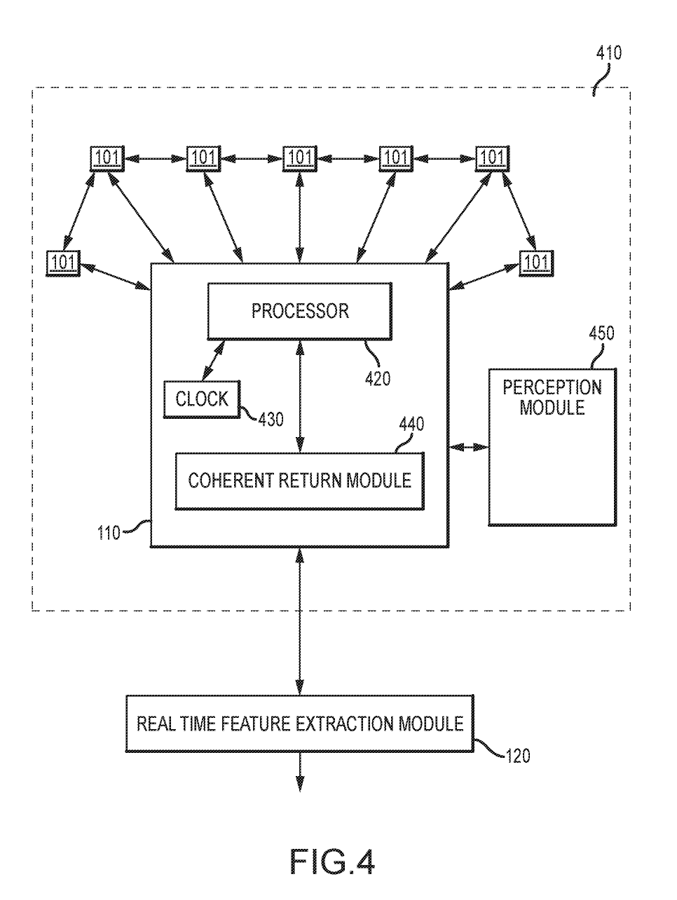

The UWB Radar Processing System 410 of FIG. 4 identifies a plurality of UWB Radars 101 communicatively coupled UWB Radar Processing Engine 110. The Radar Processing Engine 110 includes a processor 420, clock 430 and Coherent Return Module 440. Coupled to the UWB Radar Processing Engine 110 is a Perception Module 450 and the Real Time Feature Extraction Module 120 (as shown in FIG. 1).

As mentioned before, radar returns vary based on, in one instance, the reflectivity of the object. A steel pole or a concrete curb will reflect a Radar signal more effectively than a person or an animal. In addition, the shape of an animal or a person is generally distinguishable. The use of a plurality of UWB Radars 101 enable the invention to combine various radar resources to establish a specialized array to capture fine detail with respect to an object. And once the data has been collected the UWB Radars 101 can be reconfigured again to seek different details with respect to other pertinent contacts.

The invention uses a Perception Module 450 to interpret the coherent returns and, when the return(s) match a predetermine signature, reconfigure the UWB Radars 101 to gain additional information. For example, a coherent return from a forward looking UWB Radar may imply that one or more animals are directly in front of the vehicle. The Perception Module 450, recognizing the signature of an animal, can direct the UWB Radar Processing Engine 110 to reconfigure other forward looking UWB Radars 101 to form a parallel array to enhance the ability of the Radars to identify such “soft” targets. In addition, the individual characteristics, such as the scan rate, beam shaping, pulse signals, and the like, can be modified to more accurately gain information on the perceived target. Based on the iterative input between the UWB Radar Processing Engine 110 and the Perception Module 450 the UWB Radars 101 may be modified to identify certain types of edges, pedestrians, animals, vehicles, structures, railings and road even road conditions.

In addition to a parallel array the UWB Radar Processing Engine 110 can task

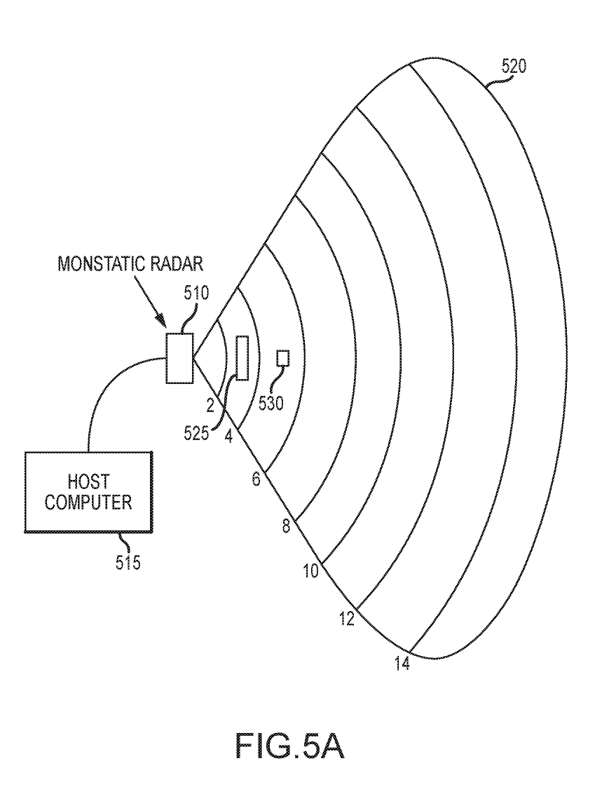

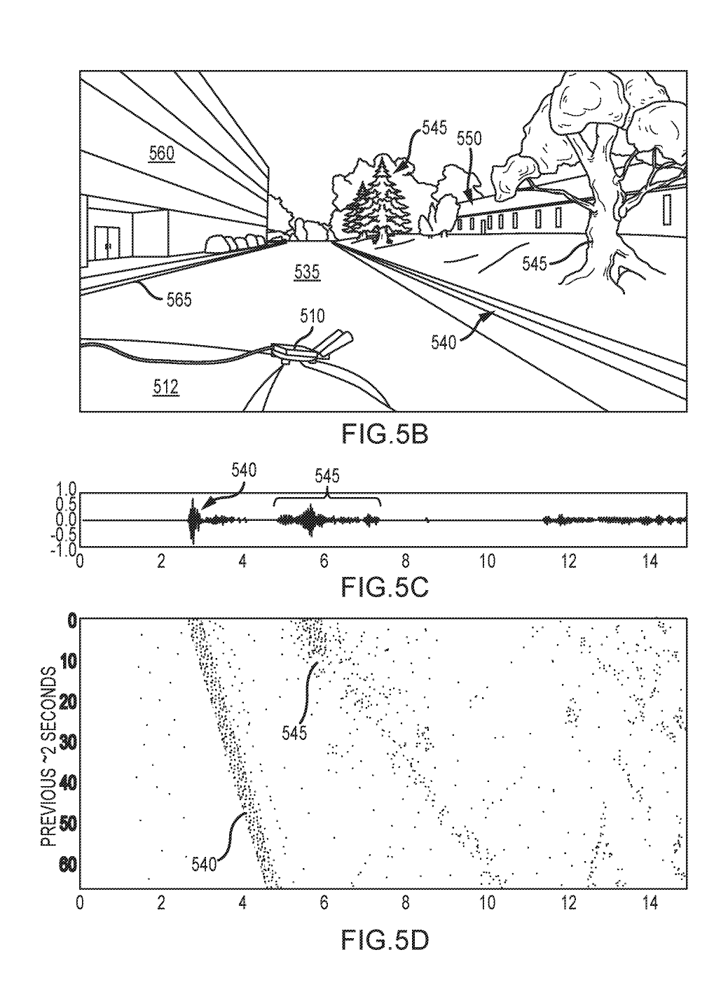

UWB Radars 101 to form a serial array or operate as sparse elements. FIG. 5A is a depiction of a monostatic UWB Radar pattern as implemented in present invention. The radar 510 produces a field of view in which a measurement of the reflectivity versus the distance occurs. The antenna pattern 520 shown produces a reflectively versus distance plot shown in FIG. 5C. The objects at three 525 and five 530 meters are identified in the reflectively plot but one of ordinary skill in the relevant art will appreciate that the single UWB Radar 510 does not know at what angle within the antenna pattern the objects exist.

FIGS. 5C-D present a visual depiction of a monostatic UWB Radar return. In this case a vehicle 512 includes a UWB Radar 510 positioned at the front right corner of the car directed outward and to the right. Within the field of view of the UWB Radar 510 is the entire front quadrant of the street 535, the curb 540, trees 545, fence and buildings 550. The building 560 and curb 565 to the left of the car is not within this UWB Radar's field or view. FIG. 5C is the return signal of the UWB Radar at an instant in time. The spikes show a return at a certain range. In this case the curb 540 presents a coherent return at approximately 3 meters and the tree 545 presents a more expansive return at 5.5 meters.

FIG. 5D is a waterfall of the UWB Radars instantaneous returns. As the curb 540 presents a continuous coherent return, the curb 540 is represented on the waterfall as a line. The remaining dark spots are transient returns such as the tree 545.

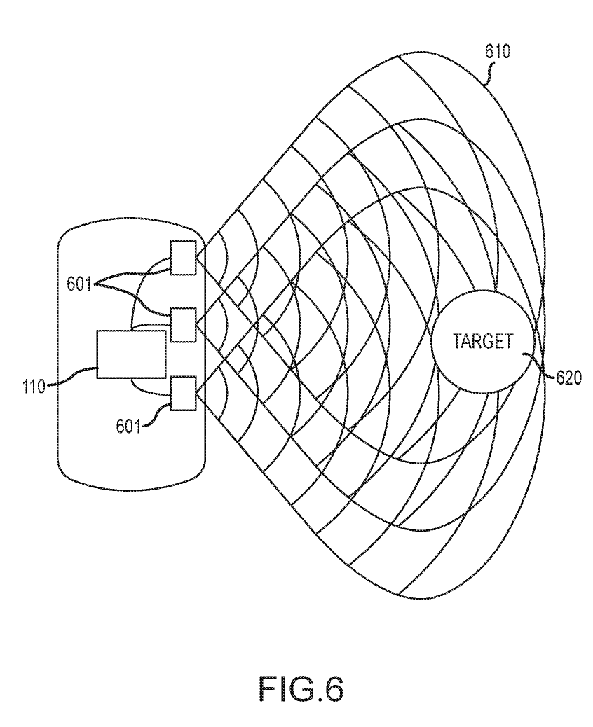

FIG. 6 depicts a sparse array of UWB Radars. Each UWB Radar 601 is operating independently but the same target is within each Radar's field of view 610. As the location of each UWB Radar 601 is different and the distance to the same target 620 is slightly different. Using this information and overlapping antenna patterns, both depth and angular information to the object can be obtained.

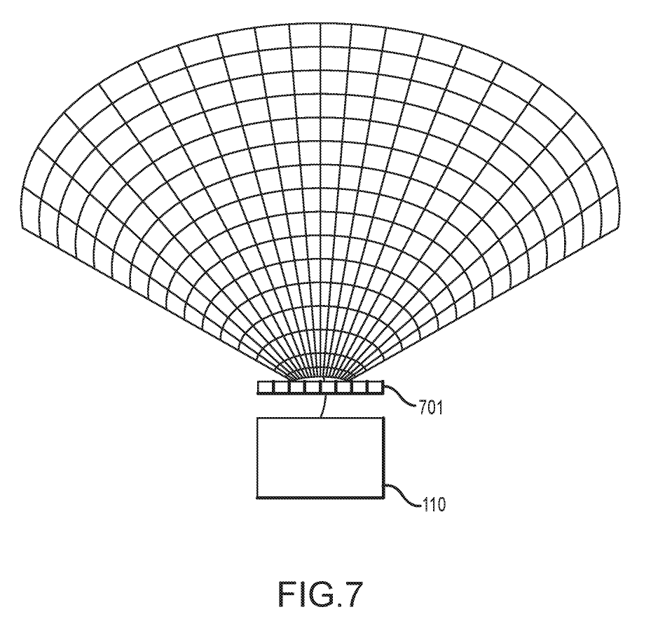

In another embodiment, a plurality of UWB Radars 701 can be configured to a parallel or phased array as shown in FIG. 7. The dense combination of synchronized RF elements (firing at the same time) can701can form an instantaneous image to provide both down-range and cross-range reflectivity. Update is faster based on the simultaneous firing. A separation distance of less than ½ of the RF wavelength allows interferometric combination, maximizing cross-axis resolution while minimizing side-lobe construction.

A serial array, for purposes of the present invention, is a sequential/timed configuration of UWB Radars. Whereas monostatic UWB Radars are connected individually to the Radar Processing Engine and firing independently (some fast, some slow depending on the environment and tasking) a serial array is a physical assemblage in which the send and receive functionality of each UWB Radar is highly coupled. In a serial array the distance and orientation are known and the UWB Radars are fired in sequence with known timing. Since the firing timing is known the return data can be manipulated to gain additional detail regarding the reflected targets.

The ability to manipulate the individual UWB Radar elements enables the present invention to create a virtual aperture for a specific time interval. UWB Radar(s) can be dynamically reconfigured to focus on a specific location or area of interest, such as an animal near the road, a human on the corner or a tumbleweed crossing the road. The ability to focus the Radar and distinguish these returns tie into the ability to position and control the vehicle. The UWB Radar can increase (or decrease) its update rate based on the relative closure speed of the object of interest. For example, a return located 20 degrees off to the right of the vehicle and moving away is of less interest than an object moving toward the car, and both may be of less interest than an object directly in front of and in the projected path of the vehicle. The invention includes the ability to real-time reconfigure a plurality of UWB Radar elements based on the perceived environment. The rate of change of the environment, or optical flow, may also drive these reconfigurations. A observation of the rate of change in a point cloud may be used to change the frequency of UWB Radar update rates of individual Radars or the overall configuration itself. Similarly, angular resolution of the Radars can be modified by changing aperture width in response to pose (angular) error.

As alluded above, the present invention has the ability to “reactively” follow a lane or road's contour by using the UWB Radar with or without active positional data from UWB tags, as the specific set of circumstances dictates, based on the multi-scan radar-return requirements of the signal processor: The higher-fidelity the raw radar return is, lessens the need for UWB tags or additional sensory data. The UWB Radar-based system provides orientations relative to curbs and lateral positions relative to curb/railing vectors that can be fed into behaviors for contour-following within a behavior engine that, in turn, controls the velocity (both direction and speed) of the vehicle, “reacting” to the contours of the road/route/path. This capability enables the vehicle to maintain position and orientation parallel to a continuous feature—a “lane”, for example—for autonomous operations. Matching the location of the vehicle on a georeferenced map, the UWB Radars can also be configured to proactively look for upcoming features or contours of the road. If the map calls for a turn to the right, for example, UWB Radars on the right side and forward portion of the car can be optimized to look for characteristics consistent with a turning road.

The present invention provides a periodic means to update position and orientation of an object to whatever degree is necessary to accomplish a specific goal using UWB Radar and/or UWB ranging radios. In one embodiment of the present invention, UWB Radars are configured to form a parallel phased array system directed toward the direction of travel. Flanking the phased array system can be UWB Radars and tags that form a sparse array. Data from these two different forms of sensor can be combined and processed to form an accurate and real time depiction of the vehicle's environment.

Another feature of the invention is its ability to use UWB tags prepositioned on signs or infrastructure along a road to aid navigation. In one embodiment, UWB Radar supports an active query/response (“ranging radio”) mode to a static UWB tag, determining range and drawing other data from the tag. Signs or posts with UWB tags affixed to them—such as exit signs or street signs—can provide exact positional data to the UWB Radar of the present invention, notifying the vehicle's autonomous operator (or human driver) that a turn or point of concern is approaching, and providing the exact remaining distance from the turn point or action location.

UWB tags and ranging radio modules can be used in a variety of configurations and applications to aid autonomous-vehicle operations. For instance, these tags and modules can provide supplemental information to the UWB Radar to determine the orientation of the vehicle relative to the feature of interest, using well-known processes of trilateration. UWB tags can also be placed in the road itself and can include means of identification that can be stored in the vehicle's database, enabling the correlation a vehicle's physical position to its position on a map. Moreover, UWB tags and UWB radars on other vehicles can be used to actively determine range, velocity, acceleration and other information for each vehicle, including relative bearing and orientation. Finally, by using peer-to-peer networks, actions of one vehicle can be immediately communicated to another appropriately equipped vehicle, so the latter can adjust its speed and path as needed.

The present invention also enables autonomous vehicle operation using corrections and inputs based on map information. Autonomous-driving algorithms and/or adaptive driver support systems can directly correlate a vehicle's corrected global position to menstruated map data control the vehicle's behavior. This correlation capability may even be intermittent, as inertial sensing and motion estimation using wheel encoders can be used to update the vehicle's UWB-based system to bridge gaps in GPS reception. In the interim, the vehicle can simply follow the sensed contours of the road edge by maintaining a fixed lateral distance, as described earlier.

A vehicle's position estimate can be improved by matching a road's characteristic radar patterns to those retained in a georeferenced map database. These roadway feature patterns can be enhanced by placing reflective features (UWB tags, specifically-shaped UWB reflectors, etc.) at precise locations. The use of such reflectors can identify lateral and longitudinal distance to the curb or other features to define the edge of the road. For example, the reflections from thin metal reflectors placed at known locations can provide variations over time in the radar returns. The time interval between these variations and the angle of signal arrival from each can be used to estimate speed and angle to each feature.

Moreover, these UWB reflectors can be placed at specifically-coded distances—rather than at equidistant intervals—to provide inherent positional data, greatly enhancing positioning accuracy as well as communicating other relevant data: The method essentially “bar-codes” the street.

The present invention combines passive and active localization techniques with map registration to enable an object to be precisely located on a georeferenced map. Using known passive and active localization techniques such as GPS, INS, Dead Reckoning, UWB Radio localization, TDOA, two-way ranging, etc., combined with onboard UWB Radar, an objects precise location and pose on a 3D feature map can be determined.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for UWB Radar Localization through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced in distributed computing environments where tasks are performed by remote processing devices that are linked through a communications network. In a distributed computing environment, program modules may be located in both local and remote memory storage devices.

An exemplary system for implementing the invention includes a general-purpose computing device, a personal communication device, ASIC or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with UWB Radar localization, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A method for spatial localization, the method comprising:
extracting from data obtained by one or more real time sensors affixed to an object, one or more real time features of a local environment;
ascertaining a georeferenced position on a georeferenced map corresponding to an estimated location of the object in the local environment;
extracting one or more map based features from the georeferenced map within a predetermined distance of the georeferenced position; and
correlating the one or more real time features with the one or more map based features from the georeferenced map to refine the estimated location of the object.

2. The method for spatial localization according to claim 1, wherein correlating the one or more real time features with the one or more map based features from the georeferenced map to refine a pose of the object.

3. The method for spatial localization according to claim 1, wherein the one or more real time sensors include one or more UWB RADARs affixed to the object.

4. The method for spatial localization according to claim 3, further comprising configuring the one or more USB RADARs as a either a parallel array, a sparse array or a serial array based on a perception of the local environment.

5. The method for spatial localization according to claim 3, further comprising configuring the one or more UWB RADARs based on a perception of an entity in a coherent return of one or more UWB RADARs.

6. The method for spatial localization according to claim 3, further comprising configuring the one or more UWB RADARs based on uncertainty in a LiDOR and/or an optical sensors associated with the object.

7. The method for spatial localization according to claim 9, further comprising configuring the LiDOR and/or the optical sensors to support the UWB RADAR.

8. The method for spatial localization according to claim 3, further comprising configuring the one or more UWB RADARs as a parallel array based on a perception of the local environment.

9. The method for spatial localization according to claim 3, further comprising configuring the one or more UWB RADARs as a serial array based on a perception of the local environment.

10. The method for spatial localization according to claim 3, further comprising configuring the one or more UWB RADARs as one or more sparse elements based on a perception of the local environment.

11. The method for spatial localization according to claim 1, further comprising estimating the estimated location based on a GPS location, an inertial navigation system, UWB Radio localization and/or a dead reckoning estimation system.

12. The method for spatial localization according to claim 1, wherein refining the estimated location of the object on the georeferenced map is based on degree of matching of map based features extracted from the georeferenced map with real time features extracted from the one or more real time sensors.

13. The method for spatial localization according to claim 12, further comprising deriving a pose of the object at the georeferenced position on the georeferenced map.

14. A system for spatial localization, comprising:
a position estimation module wherein the position estimation module is associated with a georeferenced map and wherein the position estimation module ascertains a georeferenced position on the georeferenced map corresponding to an estimated location of an object;
a map based feature extraction module communicatively coupled to the position estimation module wherein the map based feature extraction module extracts one or more map based features from the georeferenced map within a predetermined distance of the georeferenced position;
one or more real time sensors affixed to the object;
a real time feature extraction module communicatively coupled to the one or more real time sensors configured to extract real time features based on data received by from the one or more real time sensors; and
a feature correlation module communicatively interposed between the real time feature extraction module and the map based feature extraction module wherein the feature correlation module matches the one or more real time features with the one or more map based features to refine the estimated location of the object.

15. The system for spatial localization according to claim 14, wherein the one or more real time sensors include one or more UWB Radars affixed to the object

16. The system for spatial localization according to claim 15, further comprising a UWB Radar processing engine wherein the UWB Radar processing engine is coupled to the one or more UWB Radars and receives data from the one or more UWB Radars.

17. The system for spatial localization according to claim 15, wherein the UWB Radar processing engine is associated with a perception module and wherein the one or more UWB Radars are configured based on a perception of the local environment by the perception module.

18. The system spatial localization according to claim 15, wherein the configuration of the one or more UWB Radars is based on a perception of a coherent return.

19. The system for spatial localization according to claim 15, wherein the one or more UWB Radars are configured as one or more sparse elements based on a perception of the local environment.

20. The system for spatial localization according to claim 15, wherein the one or more UWB Radars are configured into a parallel array based on a perception of the local environment.

21. The system for spatial localization according to claim 15, wherein the one or more UWB Radars are configured into a serial array based on a perception of the local environment.

22. The system for spatial localization according to claim 14, wherein the estimated location is based on dead reckoning, tracking inertial movements, GPS data and/or UWB Radio localization.

23. The system for spatial localization according to claim 14, wherein UWB RADAR is configured based on uncertainty in a LIDOR system and/or an optical sensor system.
